(19) United States
(12) Patent Application Publication
(10) Pub. No.: US 2007/0130775 A1
(43) Pub. Date: Jun. 14, 2007

(54) Fingernail saving nut tool

(76) Inventor: Rockne Byron Holbrook, Fish Haven, ID (US)

Correspondence Address: Everett D. Robinson;PARSONS, BEHLE & LATIMER, Suite 220, 333 South 520 West, Lindon, UT, 84042, US

(21) Appl. No.: 11/379,376

(22) Filed: Apr. 19, 2006

Related U.S. Application Data
(60) Provisional application No. 60/748,790, filed on Dec. 9, 2005.

(51) Int. Cl. A47J 43/26; B26B 17/02

(52) U.S. Cl. 30/120.4

(57) ABSTRACT

The inventions relate generally to manual devices operable to grasp and open shelled foods such as nuts, some of which particularly relate to a tool or utensil with tips configured to be inserted into the crack of a nut, and through hand pressure open a nut through separation of the inserted tips by way of pivoting arms, whereby the tool is biased so the tips are brought substantially together for insertion in the absence of manual pressure. Certain exemplary tools include grasping surfaces, cracking jaws and pull-tab openers, as well as biasing devices such as springs in combination with pins, or flexible hinges. Tips may be chisel-pointed, round-pointed, molded from plastic or fashioned in metal. Detailed information on various example embodiments of the inventions are provided in the Detailed Description below, and the inventions are defined by the appended claims.

### CROSS REFERENCE TO RELATED APPLICATIONS

This Application claims the benefit of the U.S. Provisional Application No. 60/748,790 filed Dec. 9, 2005 which is hereby incorporated by reference in its entirety.

### BACKGROUND

There are many consumers of nuts. Many tools have appeared to assist those consumers, including a number of nut cracking or opening devices. Many of these devices are designed to open heavily-shelled nuts, such as walnuts or brazil nuts. Those devices typically operate to crush the nutshell until it fractures, after which the consumer separates the nut's meat from the shell and eats it. For lighter nuts, such as peanuts and pistachio nuts, the common practice is to leave the opening of those types of nuts to the consumer's fingers and fingernails, and a tool is not normally provided.

As one applies one's fingernails to the task of separating nut shells, he exposes them to the dust and oils of the nuts which may become lodged underneath. Additionally, fingernails are susceptible to damage and breakage as they are applied to nut shells. Thus after eating some kinds of nuts in the ordinary way a person's well-manicured fingernails may become ragged and unattractive. Furthermore, beverages are often consumed with nuts, sometimes provided in aluminum cans. A consumer's fingernails may be used to lift the pull-tab of the can, which for some with longer fingernails can produce additional stresses and damage, if a spoon, table-knife or other ad-hoc object is not conveniently nearby. Some consumers would prefer not to expose their fingernails to dirt or damage unnecessarily, particularly those who care about the appearance of their nails.

Furthermore, today nuts are usually packaged simply in a can or bag, which leaves a consumer with an impression of a blasé commodity product. Consumers may consciously or subconsciously avoid purchasing nuts in consideration of the additional shelling burdens, particularly in comparison to the wide availability of ready-to-eat foods such as potato chips or microwaveable pizza. The nut as a product could be perceptually enhanced if provided with a fun tool that reduced the shelling burdens, manufacturable at a comparatively reasonable cost to the price of nuts.

### BRIEF SUMMARY

The inventions relate generally to manual devices operable to grasp and open shelled foods such as nuts, some of which more particularly relate to a tool or utensil with tips configured to be inserted into the crack of a nut, and through hand pressure open a nut through separation of the inserted tips by way of pivoting arms, whereby the tool is biased so the tips are brought substantially together for insertion in the absence of manual pressure. Detailed information on various example embodiments of the inventions are provided in the Detailed Description below, and the inventions are defined by the appended claims.

Described herein are tools and utensils for separating nut shells that incorporate a pair of separable tips configured to be inserted into the crack in a nutshell, for example the crack that forms in the shell of a dried pistachio nut. The tips may be mounted on arms articulable about a pivot, which may be a pin and bearing arrangement or a flexible hinge, in two examples. The tools and utensils described herein are manual devices, and include handles for controlling the positions of the arms and thereby the separation of the tips. A biasing device, for example a spring or a flexible hinge, may be included to provide for return of the arms to a normal position, which may bring the tips substantially together for insertion into a crack. Tips may be chisel-shaped, round-pointed, made of softer materials such as plastic or hard materials such as metals. A tool may also include a grabbing surface useful to hold the meat of a nut and thereby create a tool useful to pick out nut meat and place it into the mouth of a consumer. Additionally, a tool as disclosed herein may be helpful to those with limited motion or coordination in their hands, such as those with neurological disease preventing fine movements between the fingers.

### BRIEF DESCRIPTION OF THE DRAWINGS

FIG. 1 depicts a first exemplary molded fingernail-saving nut opening tool.

FIG. 2 depicts one half (one arm) of the tool of FIG. 1 as viewed from the side.

FIG. 3 depicts the half shown in FIG. 2 in perspective as viewed toward the inside of the half.

FIG. 4 depicts the half shown in FIG. 2 in perspective as viewed toward the outside of the half.

FIG. 5 shows the bearing surface and pin of the other half of the tool depicted in FIG. 1.

FIG. 6 shows a pop-top opener fashioned in the end of a half of the tool depicted in FIG. 1.

FIG. 7 depicts an alternate attachment and pivoting component of the tool depicted in FIG. 1.

FIG. 8 shows in perspective a second exemplary nut-opening tool having a flexible hinge pivot.

FIG. 9 shows from the side the second exemplary tool shown in FIG. 8.

FIG. 10 depicts a third exemplary nut-opening tool fashioned largely from stamped plate metal.

FIG. 11 shows a fourth exemplary plastic nut-opening tool including both chisel and pointed tips.

FIG. 12 shows the fourth exemplary tool in the open position when squeezed upon.

FIG. 13 depicts a fifth exemplary nut-opening tool having substantially pointed tips.

FIG. 14 depicts a sixth exemplary plastic nut-opening tool having inserted metal pointed tips.

Reference will now be made in detail to some embodiments of the inventions, examples of which are illustrated in the accompanying drawings.

### DETAILED DESCRIPTION

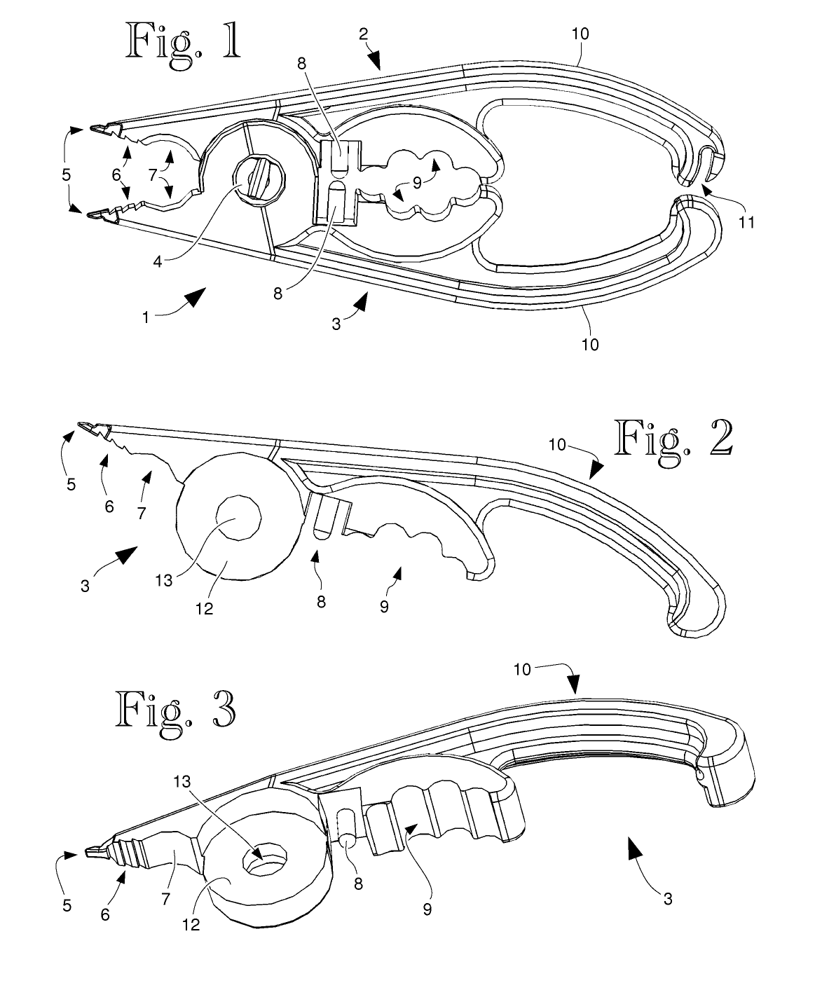

A first exemplary fingernail saving tool is shown assembled in FIG. 1, which is assembled from two halves, 2 and 3, one of which is shown in profile in FIG. 2 and in perspective in FIG. 3. Halves 2 and 3 articulate about a pivot, which in this example is a pin and bearing surface arrangement, the pin 4 visible in FIG. 1. Through articulation, halves 2 and 3 may range in relative position from open to closed, the open position shown in FIG. 1. A compression spring, not shown, may be fitted between retainers 8, thereby applying an outward force rearward of the pivot point. Tool 1 also includes handle portions 10 adapted to be manually squeezed, for example between the fingers and palm or fingers and thumb of a typical hand. When a spring is present on retainers 8, handle portions 10 are forced apart, and by squeezing pressure thereupon the tool halves 2 and 3 may be brought to articulate between any position between open and closed. Thus when no pressure is applied, halves 2 and 3 maintain a closed or relaxed position.

The first exemplary tool includes several features combined in a single fingernail saving tool. The first of these is a pair of nut splitting tips 5. Splitting tips 5 come to a substantial point that may be inserted to the crack of a pistachio nutshell or the shell of another type of nut. Thus a consumer of nuts inserts tips 5 into the crack, and squeezing pressure on handle portions 10 forces teeth 5 apart which applies separation pressure to the nutshell at the crack. Serrated grasping teeth 6 are provided in this exemplary tool for grasping nut meat or other small foods. Also in this example, tips 5, teeth 6 and the area nearby in halves 2 and 3 are fashioned without sharp edges or points, so that a consumer may use the tool 1 as a utensil for placing food in her mouth without fear of cuts or other injury.

Further included at the forward portion of tool 1 are concave jaws 7, which may be used to grasp whole nuts, small bites or other larger objects. The reader will note that providing grasping teeth and/or jaws alleviates the need for a consumer to place her hands in the food being consumed, which might be for example a bowl of nuts, and thereby reduces the exposure to dust, oils and other debris which might become lodged under her fingernails. Any of splitting teeth 5, serrated grasping teeth 6 and concave jaws 7 may provide a stop of articulation and thereby define a closed position, and in the example of FIG. 1 the closed position brings all of teeth 5, teeth 6 and jaws 7 into substantial contact. As will be seen in further examples, teeth such as 5 need not come exactly together to be effective, and may even pass each other through a tool's articulable range of motion.

Incorporated to the halves 2 and 3 behind the pivot point are cracking jaws 9. A nut may be inserted between jaws 9 and compressive pressure applied thereto. Jaws 9 are disposed near the pivot point to increase the leveraged force that can be applied to a nut caught in-between from the handle portions 10. The jaws 9 of the first exemplary tool 1 are configured for pistachios and soft nuts, and thus the handle portions 10 are located relatively close to jaws 9. For other types of nuts where increased leverage might be needed, handle portions 10 may be longer and teeth 9 made from an appropriately strong material. Also in this example, the last fingernail saving feature is a pop-top opener incorporating a slot 11 configured to receive a pull-tab of an aluminum can. The pop-top opener is more easily viewed in FIG. 6, wherein it may be seen that it utilizes a crook portion 14 pointed to pass under a pull-tab where leverage may be applied thereto through pressure to the tool body. Note that although the entrance to slot 11 is configured in this example to the inside of the tool, it might also be located elsewhere, for example to the outside or toward the end of the tool handle.

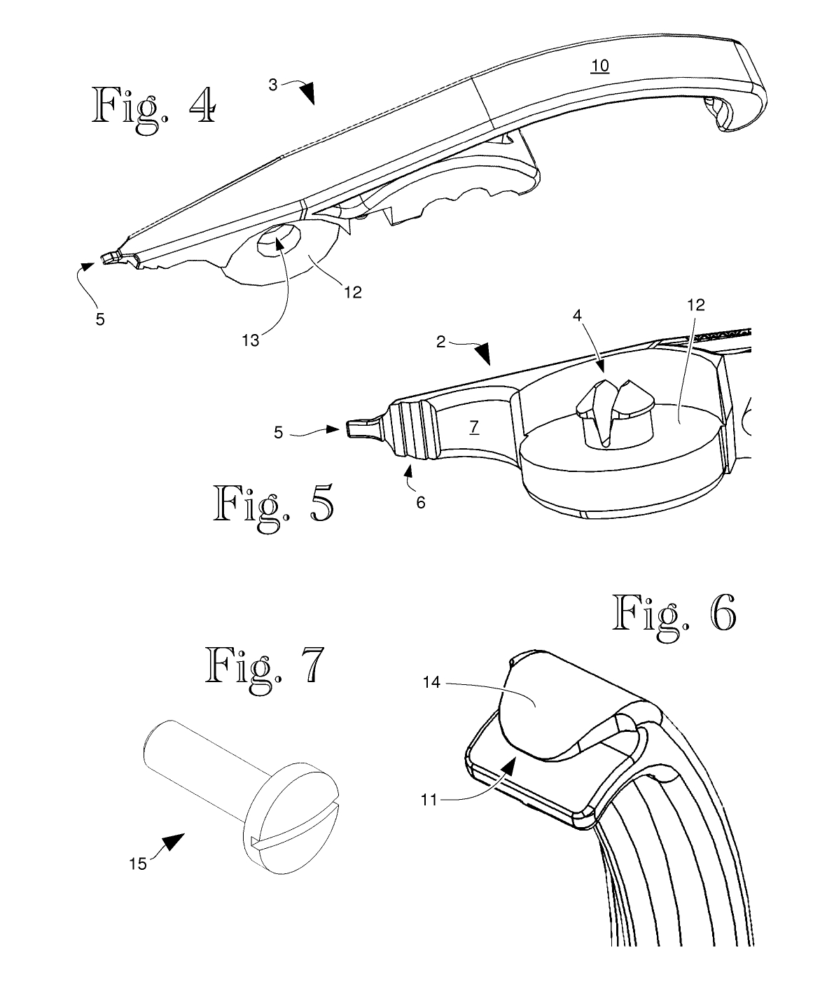

In the first exemplary tool, articulation is again provided by bearing surfaces 12, which are best viewed for half 3 in FIGS. 3 and 4. Half 2 is substantially identical to half 3, with the following differences. The first has already been discussed, which is the pop-top opener slot 11 and crook 14, which may be incorporated to either of the two halves. The second, referring now to FIG. 5, is a pin 4 incorporated at the center of bearing surface 12 rather than a hole 13 as in half 3. Pin 4 is split, and thus it may be compressed and narrowed to pass through hole 13. Pin 4 further includes locking tabs providing for locking of the two halves by the pin while permitting pivotal motion through the articulable range. Both of halves 2 and 3 are designed to be made through a thermoplastic molding process, and thus bearings 12 are made somewhat broad providing a more solid feel to the tool. If another material is used, bearings of other sizes or types may provide any feel desired.

Other pivoting devices may also be used. For example, a screw 15 as pictured in FIG. 7 might be used. In one variation, the screw includes self-cutting threads for a hole 13 in one of the halves, and the hole 13 in the other half is made larger to slip around the threads. In another variation, screw 15 is threaded only where it will meet the half distal from its head, and the hole 13 of the other half is made to accommodate the unthreaded portion of the shaft. In yet another variation, screw 15 might be entirely unthreaded, and the hole 13 in the distal half made slightly smaller for a press-fit. In that variation, screw 15 might also be serrated or barbed at the hole 13 of the distal half. Alternatively, a rivet might be used in the place of screw 15. Such a rivet might be, for example, a tabbed push-in rivet. Rivet might alternatively be secured to a distal half by bonding, glues, or chemical, thermal or ultrasonic welding. Other pivoting mechanisms may also be used, examples of which are further described below. Thus many pivoting devices can be used, the selection of which will depend on the particular manufacturing process and tool operation desired.

The first exemplary tool may be molded in thermoplastic, although it could be made in other materials or processes, for example computer-aided machining in aluminum. This, or another tool, could be made from high-density plastic to make a durable product with a solid feel. Alternatively, a tool could be made from a low-density plastic thus reducing the weight and cost of manufacture thereof. The use of fiber-reinforced plastics may provide additional strength, especially for the legs which may be under levering stress in certain uses. A lightweight tool could be supplied as a disposable utensil, and might be packaged, for example, in or with a package of nuts. If a tool is fashioned from several components, these may be provided in assembled or disassembled form, and if plastic may be provided on a tree providing a fun and easy activity for children. Likewise, these tools might also be packaged individually or in sets, and may enable pleasant social or family events where nuts and other foods are served.

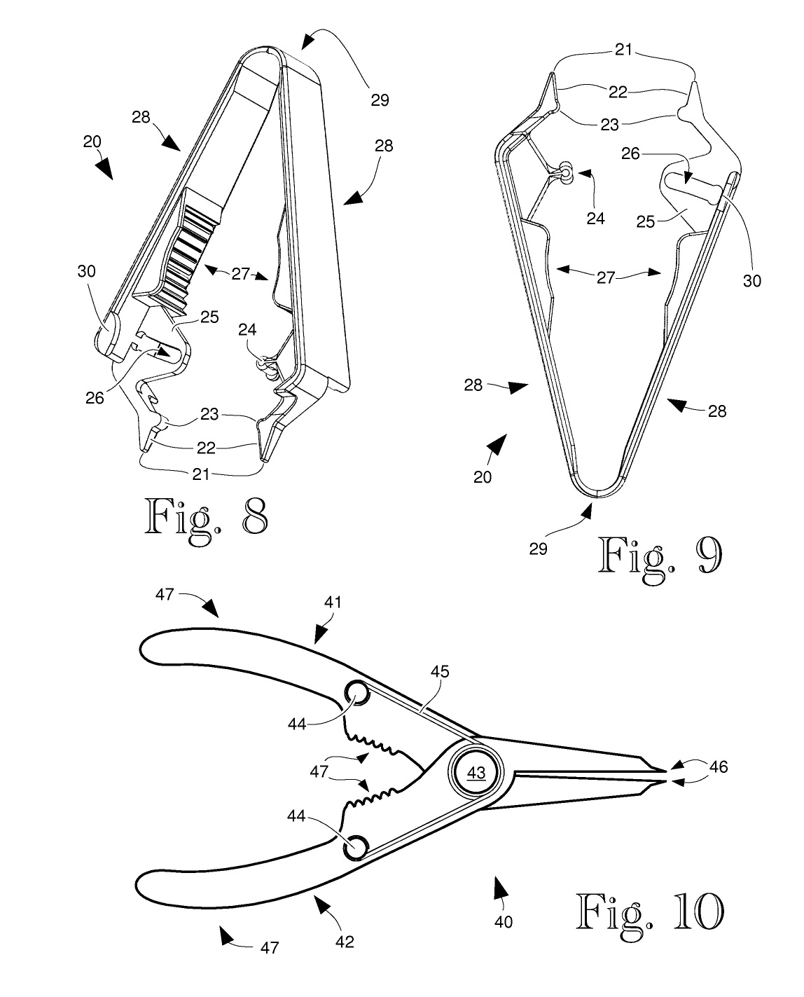

As suggested above, many types of pivots are possible. In a second exemplary tool 20 shown in FIGS. 8 and 9, the tool legs 28 pivot about and are joined by a flexible hinge 29. The articulable motion is restricted through the use of a retaining pin 24 that slides in a slot 26 formed in a bracket 25. Thus the positions shown in FIGS. 8 and 9 are those just after molding of the tool 20. Placing the tool in operating configuration is done by bringing legs 28 together by the flexible hinge 29, and aligning and inserting the flared portion of pin 24 to the widened portion of slot 26. As in the first example, tool 20 includes separating tips 21 which may be inserted into the crack of a nutshell such as a pistachio nutshell. In the operating configuration hinge 29 biases legs 28 apart, which brings tips 21 subtantially together in the resting position, i.e. with no manual pressure applied. To separate tips 21 a consumer squeezes against legs 28, which move together, and thereby increases the distance between the tips 21. Again, tips 21 need not be perfectly aligned, but rather some force may be required to bring tips together for nutshell insertion.

The second exemplary tool also includes several potentially fingernail-saving features, including a clamps 22 operable to hold small food objects, and guides 23 for stabilizing the position of tips 21 and clamps 22. Also included are jaws 27 which may be used to crack or crush nutshells. Tool 20 also includes a tongue 30 which may be inserted under under the tab of an aluminum can, wherein the tab may be raised sufficiently to pull with a finger rather than a fingernail. The second exemplary tool may also be fashioned in plastic or other materials as described above, provided hinge 29 is sufficiently flexible to articulate legs 28.

Other fingernail-saving tools may be fashioned in metals. Virtually any metal or plated metal used to make ordinary eating utensils may be used, including stainless steel or silver-plated steel. The use of metal may provide for strong, durable and long-lasting tools, and may also provide utensils that mate with other utensils used with ordinary place settings. Metal tools may be stamped with designs as with other utensils, and may by so doing be made to match a set.

Shown in FIG. 10 is a metal-based tool 40, fashioned from two legs 41 and 42 and joined with a rivet 43. Round-pointed tips 46 are included, rather than the chisel-pointed tips of the first exemplary tool. Round-pointed tips are possible for tool 40 because it is made of steel, which provides the strength necessary to avoid tip breakage. Tips 46 are biased together through spring 45, attached to pegs or rivets 44 pressed into legs 41 and 42. Tips 46 include serrations, and thus they may be used not only to separate shells but also to remove and hold a nut's meat. Also included are jaws 47 for cracking nutshells, as in the examples described above.

Tips 46 are angled outward to have about a 1/16 inch separation between in the closed or relaxed position. As these tips are round-pointed, they may be inserted into a nutshell crack in a sideways position, after which the tool is rotated 90 degrees which has a first prying effect to widen a crack. Squeezing of the handle separates the tips, widens the crack and completes the shell separation operation. These tips may or may not include serrations for grasping portions there-between, as desired.

Legs 41 and 42 may be made from rigid metal plate, for example steel plate 3/32 inch thick or greater. The length of tool 40, or any other tool described herein may be about six inches. Tool 40 is designed in a more compact form and has a length of about 5.5 inches. Likewise, other lengths may be used provided that a substantial handle is provided for manual operation.

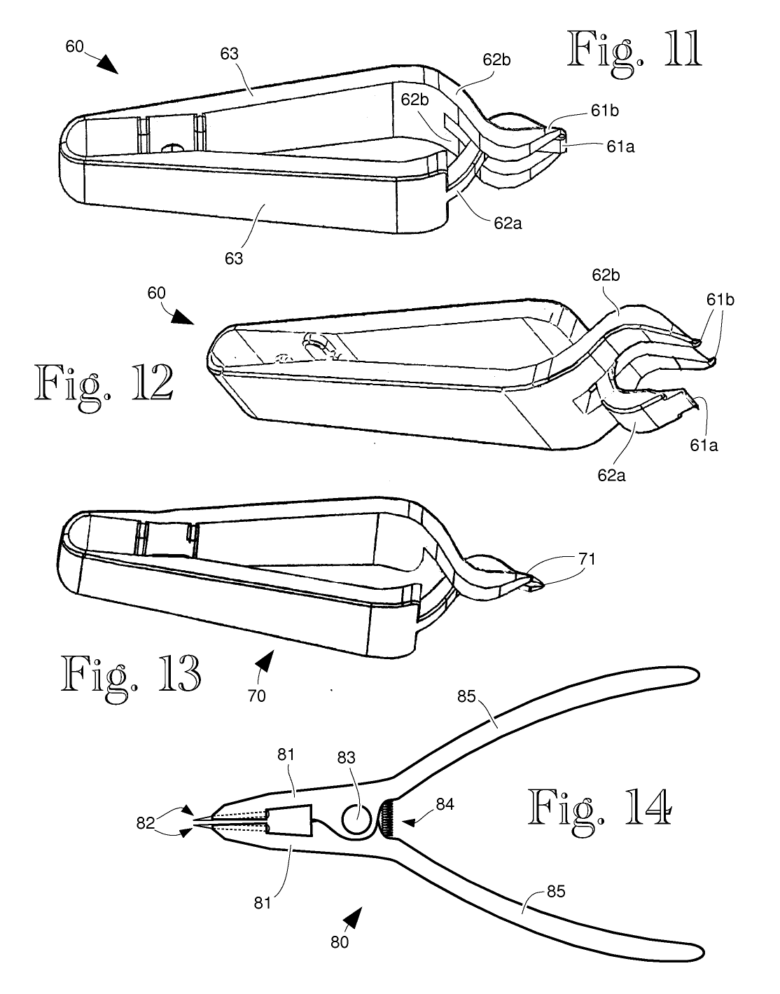

Separation tips may also take other forms than round or chisel-points. Shown in FIG. 11 is a plastic tool with a substantial chisel pointed tip 61a with surrounding pointed tips 61b. These tips are mounted on interlocking arms 62a and 62b, permitting tips 61a and 61b to pass each other. Thus as legs 63 are forced closer together, tips 61a and 61b pass each other and separate, as shown in FIG. 12. These tips align in a substantial line which is highly suitable for nutshells that tend to split on relatively straight lines, for example pistachios. This concept of arms may be used with substantially pointed tips 71, as shown for tool 70 in FIG. 13. Note that for these tools a consumer may be required to demonstrate a bit of coordination, as the tips for these tools may not meet when the tool is at rest.

In the final exemplary tool 80 shown in FIG. 14, the body of the tool is fashioned from a relatively sturdy material, such as metal, plastic or perhaps a composite material. In tool 80 is fashioned a pivot 83, which for example might be a rivet. Forward of the rivet are arms 81 that can be separated by application of squeezing pressure on handles 85. Compression spring 84 provides for a normal outward position of handles 85, and thereby a normally closed position for arms 81. Arms 81 have formed therein channels adapted to receive stainless steel tips 82, which are manufactured similarly to ordinary straight pins but not as sharp and thicker, so as not to injure its user and to provide strength against tip breakage in separating nuts for which tool 80 was designed. Thus the components of tool 80 other than tips 82 may be fashioned from materials of ordinary strength while gaining the benefit of strong tips. Tips 82 may be inserted to arms after they are made. Alternatively, tips 82 may be embedded into arms at the time they are molded in plastic, if desired. In this tool, tips 82 maintain a round point, although adaptations of other tip types may certainly be used.

Now the tools disclosed herein have included certain springs and functional spring devices, and the reader will recognize that many other spring devices could be used to provide a normal articulation position and no particular one is required. Likewise, examples of manufactures described herein are but a few possibilities, and thus other techniques might be used to make these tools and tool components, including but not restricted to molding, stamping, die-cutting, milling, machining, rolling and even hand techniques such as carving. Additionally, the serrations herein include not only linear cuts or ridges, but also indentations and ridges of any shape or arrangement, and even merely a roughened surface to provide additional securement thereof. Likewise, where teeth are disclosed, those teeth may be made more or less numerous, or smaller or larger than that disclosed, in accordance with the expectations of performance with respect to the particular types of nuts or foods for which a tool is designed.

While the present devices, products and methods have been described and illustrated in conjunction with a number of specific configurations, those skilled in the art will appreciate that other variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

1-8. (canceled)

9. A fingernail-saving nut utensil for splitting nut shells and for manipulating nut meat into a person's mouth, comprising:
a pair of articulating arms;
a pivot providing a range of motion of one of said arms relative to the other;
a pair of nut insertion tips in communication with said arms, said tips adapted to be inserted into the crack in a nutshell, said tips further having sufficient strength to withstand separation pressure;
a biasing device in communication with said arms, said biasing device providing a return force to said arms whereby said arms take a normal position in the absence of manual pressure;
a pair of opposed serrated grasping surfaces in communication with said arms, said grasping surfaces configured to hold a nut meat object therebetween under force provided by the return force of the biasing device;
handle portions in communication with said arms, said handle portions providing a grasping area of said tool, whereby a squeezing pressure may be applied and further whereby said arms may be articulated through their range of motion thereby manipulating the separation of said tips and said grasping surfaces;
whereby in the normal position said tips are brought substantially together;
and whereby with the application of manual squeezing pressure to said handle portions, said tips and said opposed grasping surfaces separate.

10. A fingernail-saving utensil according to claim 9, wherein said tips and any teeth are sufficiently dull to be comfortably inserted into a persons mouth without injury.

11. A utensil according to claim 9, wherein all of said arms, pivot, tips, teeth and handle portion are molded in plastic, and wherein said biasing device is a spring.

12. A utensil according to claim 11, wherein said arms further each comprise a bearing surface, and wherein said pivot is fashioned as a pin in one of said arms insertable to a hole in the other of said arms.

13. A utensil according to claim 9, wherein all of said arms, pivot, tips, teeth and handle portion are molded in plastic, and wherein said biasing device is a flexible hinge.

14. (canceled)

15. A tool according to claim 9, wherein said utensil further comprises a slot in communication with one of said arms and a pin adapted for said slot in communication with the other of said arms, whereby the articulation of said arms, tips and grasping surfaces may be controlled.

16. A tool according to claim 9, wherein said utensil is packaged with instructions describing the steps of:
inserting said tips into a crack in a nutshell;
applying pressure to the handle portions to separate the nutshell and gain access to the contents thereof, and
holding a nut meat object between said opposed grasping surfaces.

17. A fingernail-saving nut utensil for splitting nut shells, for manipulating nut meat into a person's mouth and for opening beverage containers having pull-tabs, comprising:
a pair of articulating arms;
a pivot providing a range of motion of one of said arms relative to the other;
a pair of nut insertion tips in communication with said arms, said tips adapted to be inserted into the crack in a nutshell, said tips further having sufficient strength to withstand separation pressure;
a biasing device in communication with said arms, said biasing device providing a return force to said arms whereby said arms take a normal position in the absence of manual pressure;
a pair of opposed grasping teeth in communication with said arms, said teeth configured to hold a nut meat object therebetween under force provided by the return force of the biasing device;
handle portions in communication with said arms, said handle portions providing a grasping area of said tool, whereby a squeezing pressure may be applied and further whereby said arms may be articulated through their range of motion thereby manipulating the separation of said tips and said teeth;
a pop-top opener incorporated to one of said arms, said opener including a slot and a crook portion pointed to pass under a pull tab, whereby through rotation of said tool leverage may be applied to the pull tab;
whereby in the normal position said tips are brought substantially together;
and whereby with the application of manual squeezing pressure to said handle portions, said tips and said opposed teeth separate.

18. A utensil according to claim 17, wherein said tips are adapted for a typical crack in a dried pistachio nut and for separation of pistachio nut halves through the crack.

19. A utensil according to claim 17, wherein said arms, tips and handle portions are formed in stainless steel.

20. A tool according to claim 17, wherein said utensil is packaged with instructions describing the steps of:
inserting said tips into a crack in a nutshell;
applying pressure to the handle portions to separate the nutshell and gain access to the contents thereof;
holding a nut meat object between said opposed teeth; and
inserting the crook portion of said pop-top opener under a pull-tab.

21. A tool for separating nut shells by the application of manual squeezing pressure, comprising:
a pair of separating tips adapted to be inserted into a crack in the shell of a nut, said tips further having sufficient strength to withstand separation pressure;
a pivoting mechanism;
handle portions providing for manual grasping of said tool, whereby a squeezing pressure may be applied;
arms in communication with said pivoting mechanism, handle portions and said pointed teeth, whereby said arms are configured to articulate the separation of said tips by manual pressure applied to said handle portions;
a biasing device in communication with said arms, said biasing device providing a force separating said handle portions from each other toward a normal position, whereby said tips are brought substantially together in the absence of squeezing pressure; and
a pair of concave nutcracking jaws disposed near said pivot point.

22. A tool according to claim 21, further comprising a feature selected from the group comprising grasping teeth, grasping clamps, grasping jaws, a tongue pull-tab opener, and a crooked pull-tab opener.

23. A tool according to claim 21, wherein said tips are angled outward such that the separation at the end of said tips can be made greater than the nutshell crack in which they operate, so as to lock the tips within the nutshell.

24. A tool according to claim 21, wherein said tips are substantially round-pointed providing for penetration of the tips into a nutshell in a location where there is no crack therein.

25. A tool according to claim 24, wherein said tips are metallic.

26. A tool according to claim 25, wherein said arms are formed through a molding process and said tips are either inserts or molded in.

27. A tool according to claim 21, wherein said tips are chisel-shaped for insertion into a substantially straight crack.

28. A tool according to claim 21, wherein said tips are configured relative to said arms to pass each other to reach the normal position.

29. A tool according to claim 21, wherein said tool is packaged with instructions describing the steps of:
inserting said tips into a crack in a nutshell; and
applying pressure to the handle portions to separate the nutshell and gain access to the contents thereof.
